(19) United States
(12) Patent Application Publication
(10) Pub. No.: US 2026/0208077 A1
(43) Pub. Date: Jul. 23, 2026

(54) COVER PLATE ASSEMBLY FOR SPIN-ON FILTERS

(71) Applicant: MANN+HUMMEL GmbH, Ludwigsburg (DE)

(72) Inventors: Brian YATES, Holly Springs, NC (US); Donald CHILTON, Gastonia, NC (US); Jeffrey BLOCHER, Dallas, NC (US)

(21) Appl. No.: 19/035,508

(22) Filed: Jan. 23, 2025

(51) Int. Cl. B01D 35/30; B01D 29/33; B01D 35/00; F01M 11/03

(52) U.S. Cl. CPC B01D 35/30; B01D 29/33; B01D 35/005; B01D 2201/30; B01D 2201/4092; F01M 11/03; F01M 2011/031

(57) ABSTRACT

An improved fluid filter is configured with a concave housing having a first end, a second end, fluid inlet ports and a fluid outlet port. A cover plate assembly is sealably attached to a second end of the housing providing a closed area with which the inlet and outlet ports communicate. The cover plate assembly contains a retainer and a thread mounting plate. An elongated cylindrical disposable fluid filter element is supported within the closed area of the housing and cover plate assembly. Fluid passes from a machine into a space between the cover plate assembly and the machine before passing through the cover plate assembly into the fluid filter for filtration. The improved retainer is provided with raised projections for directing fluid flow through the cover plate assembly into the fluid filter. The improved retainer provides improved performance and fluid flow.

### BACKGROUND

Fluid filters are used on internal combustion engines in various types of vehicles, such as automobile, bus, truck, and boat engines. Typical fluid filters have a concave housing with a first end, a second end, a fluid inlet port, and a fluid outlet port. A cover plate assembly is sealably attached to a second end of the housing providing a closed area with which the inlet and outlet ports communicate. The cover plate assembly comprises a thread mounting plate and may also comprise a gasket retainer.

Fluid filters may be tubular, with a filter media located around a perforated center tube. The filter media may be formed of material that permits the flow of fluid therethrough, but that intercepts particulate and/or solid particles. In some cases, the filter media may also absorb and retain water flowing in the lubricant. The filter media is formed around the center tube in such a way that the fluid can normally flow from the housing inlet port/ports to the housing outlet port only by passing through the filter media. Some fluid filters may have an emergency pressure release structure that may allow fluid flow to bypass the filter media in case of blockage. The filter media may be arranged within the housing, with a cover plate assembly attached to the second end of the housing in such a way as to seal the filter media inside the housing. The cover plate assembly may be arranged to provide a closed area within the fluid filter with which the inlet ports and the outlet port communicate.

The cover plate assembly includes a thread mounting plate. Thread mounting plates (also referred to as a “cover plate” or “backing plate”) are currently designed and built in plain, convex, or concave shapes, which are designed to match the mounting designs, for example, dome-up and dome-down, on engine mountings to provide for a thread start point based upon the length and orientation of the mating threaded mounting stud. The thread mounting plates are designed in various thicknesses in order to comply with mechanical strength standards as measured by hydrostatic burst tests, impulse tests, and vibration tests.

The cover plate assembly may also include a gasket retainer. The retainer may be integral with the thread mounting plate or a separate, discrete component. When integral with the thread mounting plate, the retainer can project outwardly around the radial edge, or rim, and assist with providing structure to assist with sealing, usually by positioning and retaining a gasket. Retainers may also be a separate component positioned external to the thread mounting plate, and may be arranged around the radial edge or rim, or may be arranged to cover up to the entire surface area of the thread mounting plate. Such retainers are used to enhance sealing by providing structure to assist with positioning and retaining a gasket. Retainers may also provide the geometry and mating component in which to form the closure with the cylindrical housing. Retainers can be welded, punched, or crimped and are generally constructed from relatively thin metal when arranged as a separate component. Retainers may be oriented such that they do not interfere with or overlap with any inlet or outlet ports or they may extend over some or all of the thread mounting plate. If the retainer extends over the ports, the retainer must be punched such that holes in the retainer line up with ports in the associated thread mounting plate. In either case, the retainer can be arranged to support a gasket, e.g., a rubber gasket, which serves to seal the fluid filter to the engine having its fluid filtered.

### SUMMARY

Fluid filters are utilized to extract solid particles from the lubrication systems of internal combustion engines. The fluid filter may be a spin-on filter. The fluid filter may include a rigid housing designed to be permanently or semi-permanently affixed to an internal combustion engine. The filter may instead be designed as a removable and disposable. The housing may be concave. The housing may be cup shaped. The housing has an end that is attached to an engine, the attachment end being in the form of an integral mounting end plate (also called a thread mounting plate) that has a fluid inlet port or ports and a fluid outlet port. In a typical arrangement, a fluid outlet port may be centrally positioned in the housing end plate, and a fluid inlet is in the form of a plurality of openings spaced around and separate from the fluid outlet port. The fluid outlet port may also function as a means of mounting the housing to an engine.

Fluid filters may have a cover plate assembly that is sealably attached to the end of the housing which will be attached to an engine. The cover plate assembly includes a thread mounting plate and may also include a retainer. Traditional retainers may be a layer of thin metal arranged external to the thread mounting plate and designed to hold a gasket, e.g., a rubber gasket for improved sealing. One embodiment presented herein is directed to an improved retainer which extends to cover the thread mounting plate, with holes punched to match fluid inlet and fluid outlet ports in the thread mounting plate. The retainer is made of thinner steel relative to the thread mounting plate and in an embodiment the retainer sits as an external layer on the thread mounting plate arranged to cover the external surface of the thread mounting plate. One embodiment presented herein features an improved retainer provided with raised features in the form of texture or projections such as corrugations, ribs, or beads arranged on the retainer, e.g., placed between adjacent inlet ports, for improved flow dynamics. The raised texturing or projections may be added at different points in the manufacturing process. Raised projections or texture placed on the external face of the retainer improve flow dynamics as the fluid passes through the inlet holes and the fluid filter. The inlet holes can be of various geometric shapes and vary in the number of total inlet holes normally equally spaced around a diameter. The raised projections or texture can be configured and arranged to guide fluid passing into the filter from the space outside the retainer into the inlet holes. The raise projections can be modified based on the size, shape, location, and quantity of the inlet holes.

An important advantage of the improved retainer over thread mounting plates is that the textures, corrugations, ribs, or beads produce improved flow characteristics as fluid moves through the filter. Other aspects, features, and techniques of the invention will be apparent to one skilled in the art in view of the following detailed description of the invention.

### BRIEF DESCRIPTION OF DRAWINGS

FIG. 1a is a partial cross-sectional view of a fluid filter according to the prior art.

FIG. 1b is a partial cross-sectional view of a fluid filter according to the prior art.

FIG. 1c is a partial cross-sectional perspective view of a fluid filter according to the prior art.

FIG. 2 is top view of a retainer according to the prior art.

FIG. 3 is a top view of an improved retainer according to an embodiment.

FIG. 4a is a cross-sectional view of an improved retainer according to an embodiment.

FIG. 4b is a cross-sectional view of an improved retainer according to an embodiment.

FIG. 5 is a top view of an improved retainer according to another embodiment.

FIG. 6 is a top view of an improved retainer according to another embodiment.

FIG. 7 is a top view of an improved retainer according to another embodiment.

FIG. 8 is a top view of an improved retainer according to another embodiment.

FIG. 9 is a top view of an improved retainer according to another embodiment.

FIG. 10 is a top view of an improved retainer according to another embodiment.

FIG. 11 is a top view of an improved retainer according to another embodiment.

FIG. 12 is a top view of an improved retainer according to another embodiment.

FIG. 13 is a perspective view of a fluid filter equipped with the improved retainer of FIG. 5.

### DETAILED DESCRIPTION

Fluid filters are important components for machines relying on fluid which may become contaminated with particulate and impurities. In particular, fluid filters are necessary to assist with filtering fluid which might otherwise damage the machine through which it circulates if too much particulate or too many impurities accumulate in the fluid as it circulates. Fluid passing from the machine, i.e., an internal combustion engine, with particulate or impurities, i.e., dirty fluid, will enter a space between the machine and an attached fluid filter before passing through inlet ports in the cover plate assembly of the fluid filter. The fluid dynamics of the traveling dirty fluid may affect the efficiency and effectiveness of the fluid filter. An improvement over the flat surfaced cover plate assemblies of the prior art involves providing raised surfaces on the external surface of the retainer to assist with beneficial flow dynamics for dirty fluid flow. The improvements include better filter performance, better oil cleaning, more uniform oil pressure, higher quality, and higher durability.

An embodiment of a fluid filter with a modified retainer has improved flow characteristics compared to traditional designs. In one embodiment, an improved retainer is provided with corrugations, ribs, or beads arranged around the retainer and may be placed between adjacent inlet port holes. The corrugations, ribs, or beads and may be added at different points in the manufacturing process. For example, achieved through a stamping process, like, e.g., a cold forming press operation, that precedes the attachment of the retainer to the cover assembly. They may alternatively be added during the clinching process where the retainer and baseplate are pressed together. The either by clinching or welding the retainer to the thread mounting plate to form the cover plate assembly. Thus, the projections are made from the same material as the retainer. In an alternative embodiment, the projections could be added after construction of the retainer and made of another material. In another embodiment, the projections could be added in an injection molded process as a separate component or as an integral feature in the overall plate design.

When the cover plate assembly is attached to the housing, a closed area is formed with which the outlet and inlet ports communicate. Mounted within the enclosed area formed by the housing and the cover plate assembly is a filter element. The filter element preferably has a perforated center tube, a first end of which is in detachable communication with the housing end plate fluid outlet port. The second end of the center tube is typically closed.

Inlet ports may be provided in a variety of shapes, including circular, oblong, or any polygonal shape such as hexagonal, heptagonal, octagonal, etc. The inlet ports may comprise more than one shape as well. In the event of more than one shape for inlet ports, the arrangement may utilize equal numbers or each shape, or any number of each shape as desired.

In one embodiment, an improved retainer positioned over a thread mounting plate is provided with texturing, corrugations, ribs, or beads projecting outward to improve flow characteristics. The texturing, corrugations, ribs, or beads can be formed on the circumferential groove outside of the area where the inlet ports are located.

In another embodiment, an improved retainer positioned over a thread mounting plate is provided wherein the corrugations, ribs, or beads can be formed between the inlet ports of the retainer.

In another embodiment, an improved retainer positioned over a thread mounting plate is provided wherein the corrugations, ribs, or beads can be formed between the inlet ports and in addition, on the circumferential groove outside of the area where the inlet ports are located.

The raised projections on the surface of the improved retainer serve to direct or guide fluid flow such as to improve flow dynamics such as pressure drops, as well as filter functionality and efficiency. The raise projections can help disperse incoming fluid such that said fluid does not strike the retainer surface orthogonally.

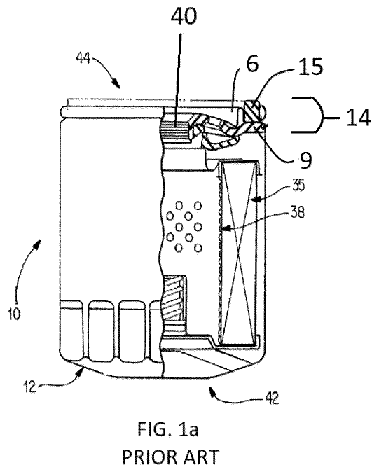

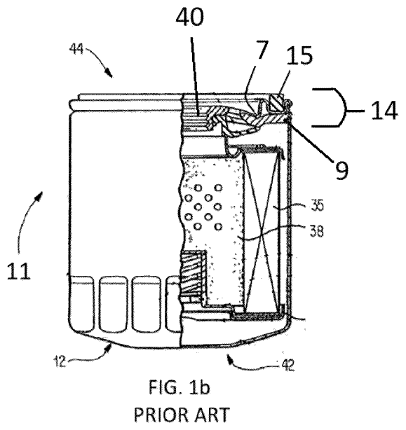

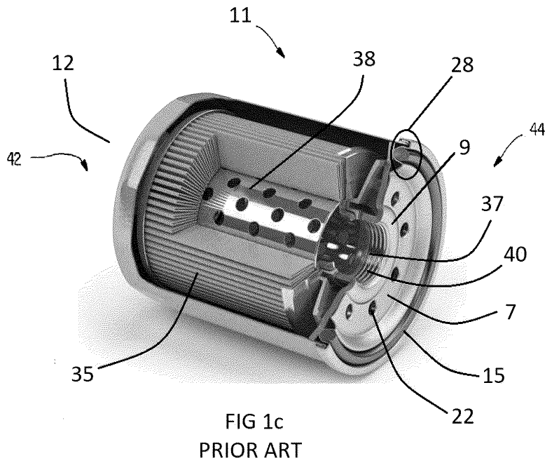

FIG. 1a illustrates a fluid filter 10 according to the prior art. The fluid filter 10 includes a concave housing 12 having a first end 42, a second end 44, a fluid inlet port 21 (not shown) and a fluid outlet port 37 (not shown). A cover plate assembly 14 is sealably attached to a second end 44 of the housing 12 providing a closed area with which the inlet ports 21 and outlet port 37 communicate. The cover plate assembly 14 includes a retainer 6 and a thread mounting plate 9. An elongated cylindrical filter element 35 is supported within the closed area of the housing 12 and cover plate assembly 14. The filter element 35 comprises filter media and surrounds a perforated center tube 38, where a first end of the center tube communicates with the fluid outlet port 37 and the other end of the center tube is closed. The center tube 38 supports the filter media such that fluid flow into the closed area through the inlet port 21 flows through the filter media and into the center tube 38 to then pass out through the outlet port 37.

Centrally formed within thread mounting plate 9 is a central outlet port 37 having internal threads 40 therein. Inlet ports 21 are spaced circumferentially around outlet port 37. The fluid filter 10 is attached to an internal combustion engine by rotating housing to thread outlet port 37 onto an externally threaded tubular support (not shown) so that gasket 15 sealably engages a planar sealing surface (not shown). The sealing surface (not shown) has oil flow channels in communication with inlet ports 21. Thus, in a manner that is typical of the way that fluid filters are commonly attached to an internal combustion engine, the housing 12 is threaded onto an externally threaded tubular member to simultaneously make attachment to an engine lubrication system that includes flow channels that provide communication with fluid filter inlet ports 21 and outlet port 37.

FIG. 1b illustrates a fluid filter 11 according to the prior art with a retainer arranged separately from the thread mounting plate. The design is generally similar to the configuration of FIG. 1a, but with the retainer of the cover plate assembly being a separate and discrete component. In this arrangement, the thread mounting plate also includes a central threaded bore co-located with the outlet port 37 and is designed for attachment to a machine. In this arrangement, the thread mounting plate comprises thicker, most substantial construction than the retainer. The thread mounting plate is often metal, such as a dense metal like steel. The metal for the plate may be hot-rolled-pickled-oiled (“HRPO”). The metal for the plate could be a stainless steel in some applications. The retainer comprises thinner, lighter metal, e.g., aluminum. The outer circumferential edge of the retainer 7 is normally folded and interleaved or rolled with the outer circumferential edge of the filter housing 10 during manufacture of the filter structure. This folded and interleaved joint or rolled seam provides a fluid pressure-tight connection for the filter interior. The retainer, sometimes called an end plate, may form an annular gasket retainer channel 28. The gasket 15 is designed to fit in the channel 28. The gasket 15 is provided having a generally ring-like or annular configuration and a sealing surface that will engage the machine when the filter 10 is screwed onto the machine to prevent leakage. The gasket 15 may be made of rubber, or rubber-like material, which will compress slightly under pressure, but offers sufficient firmness so as to become firmly seated and form a tight seal at the sealing surfaces of the filter and the filter mount upon spin-on installation of the filter thereto.

FIG. 1c illustrates a perspective view of the fluid filter 11. Fluid filter 11 comprises a concave housing 12 having a first end 42 and a second end 44. FIG. 1c illustrates a cross-section of filter 11, including perforated center tube 38, filter element comprising filter media 35, thread mounting plate 9, retainer 7, circumferential groove 28, gasket 15, inlet ports 22, and outlet port 37. As can be seen in this perspective view, the retainer 7 sits atop the threat mounting plate 9, with co-located ports for inlet and outlet of fluid. The outlet port for the retainer may be larger than the outlet port for the thread mounting plate, as accommodation may be required to ensure easy access and fit for a threaded mount for the filter on a machine. In the conventional design, the retainer surface extending across the thread mounting plate surface is smooth and continuous but for openings coinciding with openings on the thread mounting plate for fluid passage.

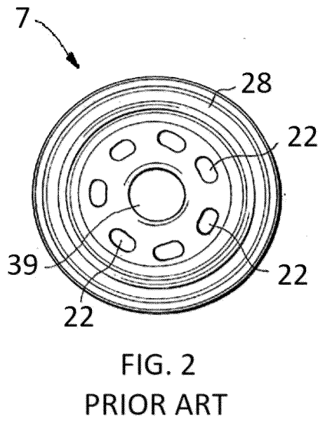

FIG. 2 illustrates a top view of a retainer 7 according to the prior art. Conventional retainer 7 includes inlet ports 22, outlet port 39, and circumferential groove 28. Retainer 7 would be placed on the external face of a thread mounting plate such that retainer inlet ports 22 align with thread mounting plate inlet ports 21 and retainer outlet port 39 aligns with thread mounting plate 37. The edge of retainer 7 would be arranged to curve around the edge of housing 12 to seal and finish the assembly of filter 11.

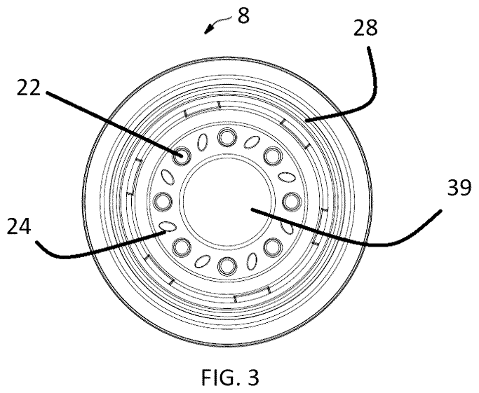

FIG. 3 illustrates an embodiment of an improved retainer 8. In this configuration, inlet ports 22 are round in shape, being placed equally far apart around a circumference of the retainer around the central outlet port 39. In between the inlet ports 22 are arranged raised beads 24 projecting outwardly, e.g., rice shaped beads. Whereas the inlet ports are arranged as round, the beads 24 are oriented at an angle relative to a radius of the retainer. In this embodiment, eight inlet ports are utilized along with eight raised projections. The number, size, and shape of inlet ports and raised projections can be varied based on the needs of the particular filter. The number of inlet ports may be the same as the number of raised projections. The number of inlet ports may alternatively be different, more or less, than the number of raised projections. The shape of the inlet ports and the raised projections may all be the same or they may be varied. The raised beads are configured such that fluid flowing over the retainer face may be directed to flow circularly or substantially circularly. Fluid directly hitting beads will be dispersed laterally or at an angle and more effectively than when hitting a flat retainer surface. The beads may alternatively be oriented radially or circumferentially. The raised beads 24 serve to guide or direct the fluid.

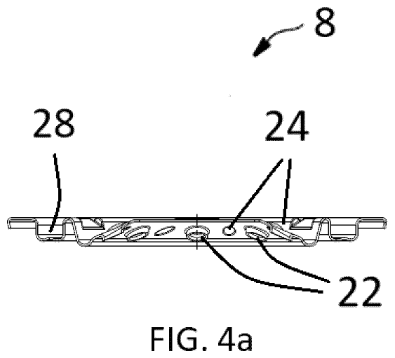

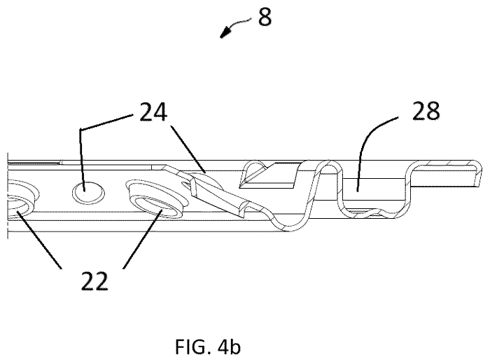

FIG. 4a illustrates a cross-section of an improved retainer 8. Visible in the cross-section are inlet holes 22, raised projections 24, and gasket channel 28. In this example, inlet holes 22 are round and evenly spaced around a central outlet port (not visible) and raised projections 24 are round and punched to project upward. A gasket channel 28 is provided for placement of a, i.e., rubber gasket to assist with sealing. In this embodiment, inlet holes 22 are extruded for clinching or swaging to the thread plate on which the improved retainer will be placed. While the embodiment in FIG. 3 features raised projections which are formed as distensions or deformations of the retainer material, the raised projections can also be added material and configured as solid, thin, hollow, or pass-through as additional inlets. In some embodiments, the face of the retainer from which the projections arise will be arranged parallel and adjacent to the thread mounting plate. Alternatively, a portion of the face of the retainer from which the projections arise, may be arranged at an angle to the thread mounting plate such that a space may be formed between the retainer and the plate through which fluid flows to assist with fluid flow.

FIG. 4b illustrates another cross section of improved retainer 8, albeit a magnified view of approximately half of FIG. 4a.

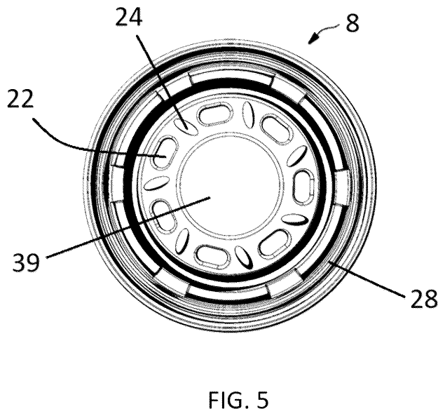

FIG. 5 illustrates an alternative embodiment. In this configuration, inlet ports 22 are oblong in shape, with their length running circumferentially around the central outlet port 39. In between the inlet ports 22 are arranged raised beads 24 projecting outwardly, e.g., rice shaped beads. Whereas the inlet ports may be arranged perpendicularly to a radii of the retainer 8, the beads 24 are oriented at an angle relative to such a radius. In this embodiment, there are provided seven inlet ports and seven raised projections. As noted regarding FIG. 3, the number of inlet ports and raised projections may be varied based on the needs of the particular filter application. The beads are configured such that fluid flowing over the retainer face may be directed to flow circularly or substantially circularly. Fluid directly hitting beads will be dispersed laterally and more effectively than when hitting a flat retainer surface. The beads may also be oriented radially or circumferentially.

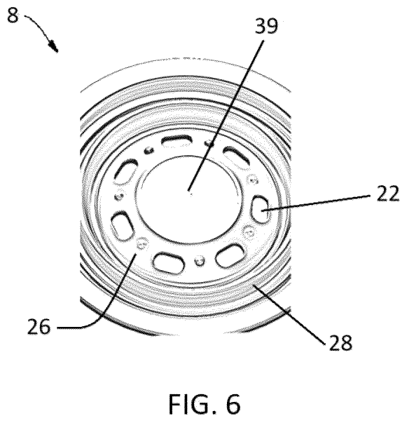

FIG. 6 illustrates another alternative embodiment. In this embodiment, instead of rice-shaped or oblong beads, the projections are arranged as round beads 26. The round beads 26 are configured to disperse incoming fluid equally in all directions, assisting with flow characteristics for dirty fluid prior to entering the fluid filter through input ports 22.

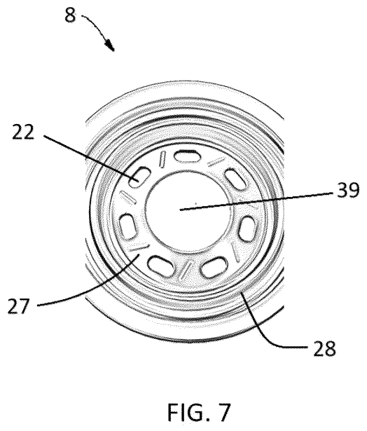

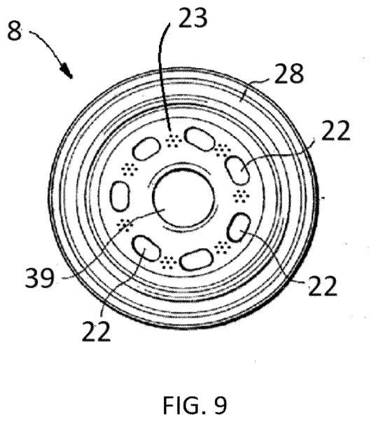

FIG. 7 illustrates another alternative embodiment. In this embodiment, instead of rice-shaped or oblong beads, the projections are arranged as elongated bars 27. The bars 27 are configured to disperse and direct incoming fluid in a desired direction, assisting with flow characteristics for dirty fluid prior to entering the fluid filter through input ports 22. The embodiment of FIG. 9 is similar to the embodiment of FIG. 7 and is illustrative of an improved retainer with improved flow characteristics. The bars 27 are arranged at an angle relative to a radius of the retainer 8, and may be oriented, e.g., circumferentially or radially.

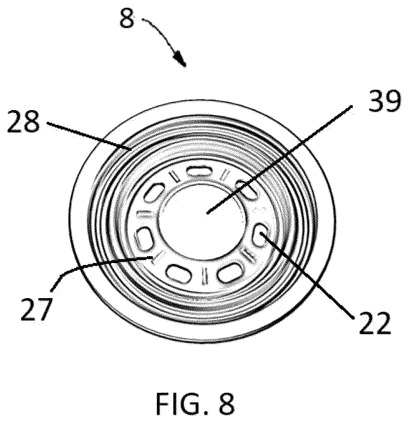

FIG. 8 illustrates an alternative embodiment where bars 27 are positioned between adjacent inlet ports 22 and oriented radially inside the groove 28.

FIG. 9 illustrates another embodiment of an improved retainer 8 according to the invention. In this embodiment, the surface area of the retainer 8 between inlet ports 22 is provided with a texture such that the texture projects towards second end 44 when installed. The raised texture is arranged such that fluid flowing into the fluid filter through inlet ports 22 passes over the raised texture as the fluid passes from the machine into the filter. In particular, as fluid from the machine needing filtering, i.e., dirty fluid, pumps through the space above or outside the retainer body, the fluid may swirl due pressure forcing the fluid into the filter. Additionally, the texturing may be shaped or configured such that fluid passing over the texturing is directed in a particular direction, e.g., rotationally. The texturing may be a singular shape or multiple shapes with uniform height or differing heights. The texturing may be configured as bumps, beads, ribs, pyramids, corrugations, or other shapes. The texturing may be placed between the inlet ports, interior to the inlet ports closer to the outlet port, or exterior to the inlet ports closer to the circumferential groove.

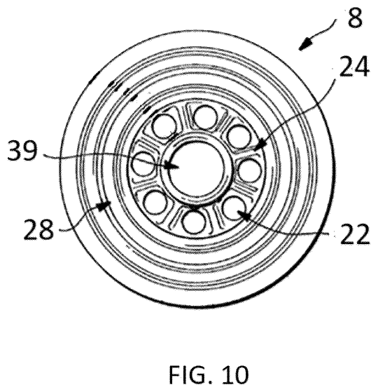

FIG. 10 illustrates another embodiment of an improved retainer 8. In this embodiment, the retainer 8 is provided with ribs 24 arranged between adjacent or subsequent inlet ports 22. The ribs could be configured as rounded, squared, peaked, or pyramidal. The ribs could also be circular, oval, or polygonal. The ribs may be smooth or corrugated. In this embodiment, the ribs are formed in between inlet ports and are raised towards the engine, that is, the ribs are formed on the surface of the retainer facing towards second end 44, the end that will face the machine upon installation of the fuel filter. In this embodiment the projections or ribs 24 are arranged perpendicularly to a circle concentric with the outlet port hole 39 of the retainer 8. In other words, the ribs or protrusions 24 are arranged parallel to or concurrent with radii from the center to the edge of the retainer 8. In this example, the ribs or protrusions are arranged internal to circumferential groove 28, which is designed to hold a sealing gasket 15. The ribs or protrusions 24 could alternatively be arranged at uniform, consistent angles relative to a radius of the retainer 8. The ribs or protrusions 24 could alternatively be arranged at differing angles relative to a radius of the retainer 8.

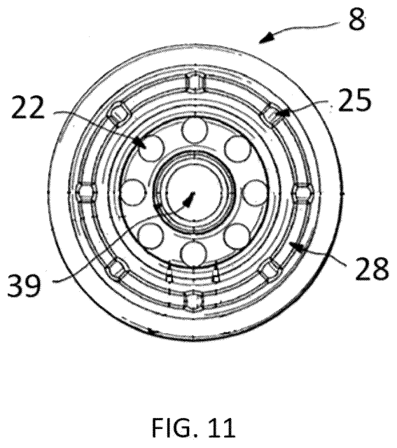

FIG. 11 illustrates another alternative embodiment of the improved retainer 8. This improved retainer has ribs 25, which may be smooth or corrugated, formed on the circumferential groove 28 outside of the area where the inlet ports 22 are located and are raised towards the machine. The design of the ribs 25 can be modified in any manner that is possible in light of the above teachings. For example, the ribs can be any of the shapes, orientations, configurations, and locations described herein. The ribs can be, e.g., oriented radially to the center or concentric to the center or radially to the gasket or concentric to the gasket.

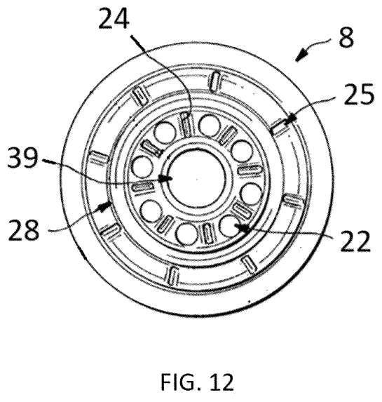

FIG. 12 illustrates yet another alternative embodiment of the improved retainer 8. This improved retainer has ribs 24, which may be smooth or corrugated, in between the inlet ports 22 and on the circumferential groove 28 outside of the area where the inlet ports 22 are located and raised toward the engine. As with previous embodiments, the specific shape and orientation of ribs 24 and ribs 25 may be uniform or varied, perpendicular, angled, or parallel to a radius, but project towards the second end of the fluid filter.

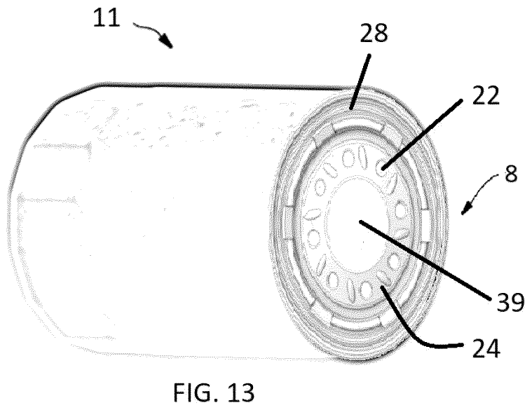

FIG. 13 illustrates a fluid filter 11 equipped with the improved retainer 8 of FIG. 5. Improved retainer 8 is illustrated atop a thread mounting plate sealing the filter 11. When the fluid filter is attached to a machine, the spin-on filter is screwed onto the machine via a threaded projection from the machine being inserted into outlet port 39, which will be configured with threads to accomplish a secure fit.

The design of the corrugated ribs can be modified in any manner that is possible in light of the above teachings. For example, the corrugated ribs can be radial to the center or concentric to the center or radial to the gasket or concentric to the gasket. In addition, the teachings of the present invention can be applied to any structure or materials that may be understood as within the scope of the appended claims.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

1. A fluid filter assembly, comprising:
a housing having a first end and a second end;
a cover plate assembly sealably attached to the second end of the housing providing a closed area, wherein said cover plate assembly further comprises a retainer and a thread mounting plate, said retainer having at least one retainer fluid inlet port and a retainer fluid outlet port aligned with at least one plate inlet port and a plate outlet port, respectively;
a perforated center tube, a first end of which communicates with the fluid outlet port, the other end of the center tube being closed; and
an elongated cylindrical fluid filter element comprising filter media arranged within the closed area defined by the housing and the cover plate assembly,
wherein the filter media is arranged around the center tube such that fluid flows into the closed area through said at least one retainer inlet port and plate inlet port, then flows through the filter media and into the center tube to pass out through the plate outlet port and retainer fluid outlet port; and
wherein an external face of the retainer comprises a plurality of raised projections configured to interact with fluid prior to the fluid flowing through the at least one retainer fluid inlet port.

2. The fluid filter assembly of claim 1, further comprising a circumferential groove arranged on the retainer external to the at least one retainer fluid inlet ports.

3. The fluid filter assembly of claim 2, wherein the plurality of raised projections are arranged internal to the circumferential groove.

4. The fluid filter assembly of claim 3, wherein the plurality of raised projections are arranged as a texture.

5. The fluid filter assembly of claim 3, wherein the plurality of raised projections are arranged as corrugated ribs.

6. The fluid filter assembly of claim 3, wherein the plurality of raised projections comprise corrugated ribs.

7. The fluid filter assembly of claim 1, wherein the plurality of raised projections comprise rice bead shapes.

8. The fluid filter assembly of claim 1, wherein the plurality of raised projections comprise round bead shapes.

9. The fluid filter assembly of claim 1, wherein the plurality of raised projections comprise elongated bar shapes.

10. The fluid filter assembly of claim 2, wherein the plurality of raised projections are arranged on the circumferential groove.

11. The fluid filter assembly of claim 10, wherein the corrugated ribs are concentric to the circumferential groove.

12. The filter assembly of claim 10, wherein the corrugated ribs are radial to the circumferential groove.

13. The fluid filter assembly of claim 1, having at least two retainer inlet ports, wherein the raised projections are formed in between the retainer inlet ports.

14. The fluid filter assembly of claim 13, wherein the corrugated ribs are concentric to the inlet ports.

15. The fluid filter assembly of claim 13, wherein the corrugated ribs are radial to the inlet ports.

16. The fluid filter assembly of claim 1, having at least two inlet ports, wherein the corrugated ribs are formed in between the inlet ports and on a circumferential groove outside of an area where the inlet ports are located.

17. The fluid filter assembly of claim 16, wherein the corrugated ribs formed in between the inlet ports are concentric to the inlet ports and the corrugated ribs formed on the circumferential groove outside of the area, and wherein the inlet ports are located concentric to the circumferential groove.

18. The fluid filter assembly of claim 16, wherein the corrugated ribs formed in between the inlet ports are radial to the inlet ports and the corrugated ribs formed on the circumferential groove outside of the area, and wherein the inlet ports are located radial to the circumferential groove.

19. A cover plate assembly for a fluid filter, comprising:
a retainer; and
a thread mounting plate;
wherein the retainer is arranged having at least one retainer fluid inlet port and a retainer fluid outlet port aligned with at least one plate inlet port and a plate outlet port in the thread mounting plate; and
wherein the retainer is configured to have a plurality of raised projections on an external face of the retainer configured to affect flow of fluid passing through the at least one retainer fluid port and the corresponding plate inlet port.

20. The cover plate assembly of claim 19, wherein the raised projections on the external face of the retainer are arranged between adjacent retainer fluid inlet ports.
